(19) United States
(12) Patent Application Publication
(10) Pub. No.: US 2025/0182506 A1
(43) Pub. Date: Jun. 5, 2025

(54) SYSTEMS AND METHODS FOR PARTICLE CLASSIFICATION USING MACHINE LEARNING

(71) Applicant: Life Technologies Corporation, Carlsbad, CA (US)

(72) Inventors: Nicolas Rognin, Carlsbad, CA (US); Christopher Cole, Carlsbad, CA (US); Jeremy Duke, Carlsbad, CA (US); Kim Ippolito, Carlsbad, CA (US); Austin Kearns, Carlsbad, CA (US); Larry Rystrom, Carlsbad, CA (US); Matthew Shallice, Carlsbad, CA (US); Erin Taylor, Carlsbad, CA (US)

(21) Appl. No.: 18/957,412

(22) Filed: Nov. 22, 2024

Related U.S. Application Data
(60) Provisional application No. 63/604,673, filed on Nov. 30, 2023.

(51) Int. Cl. G06V 20/69; G06F 18/2413; G06V 10/762; G06V 10/774

(52) U.S. Cl. CPC G06V 20/698; G06F 18/24147; G06V 10/762; G06V 10/774

(57) ABSTRACT

Disclosed herein are machine learning-based particle classification systems, as well as related methods, computing devices, and computer-readable media. For example, in some embodiments, a particle classification system may include: an electronic processing device configured to: receive, from an imaging flow cytometer instrument, a test set comprising unlabeled data to classify; pool the test set and a training set into a concatenated dataset comprising a plurality of parameters, wherein the training set comprises labeled data; normalize the concatenated dataset by bringing the variance to one for each of the plurality of parameters; non-linearly reduce a dimensionality of the normalized concatenated dataset to a reduced dimension space; compute classification parameters by classifying the unlabeled data from the reduced dimension space using the labeled data from the reduced dimension space; and provide the classification parameters for further processing.

### RELATED APPLICATIONS

This application claims priority to U.S. Provisional Patent Application No. 63/604,673, filed Nov. 30, 2023, the entire content of which is incorporated herein by reference.

### FIELD

This disclosure generally relates to analyzing particles, such as, for example, via flow cytometry. More specifically, the present disclosure relates to analyzing imaging flow cytometry (IFC) data powered by artificial intelligence (AI).

### BACKGROUND

Flow cytometry is a technique used to detect and measure physical and chemical characteristics of a population of cells or particles. IFC combines the high-event-rate nature of flow cytometry with the advantages of single-cell image acquisition associated with microscopy. The measurement of large numbers of features from the resulting images provides rich data sets that have resulted in a wide range of biomedical applications.

### SUMMARY

The systems and methods described herein provide an image-based particle classification solution that employs machine learning via non-linear dimensionality reduction of processed data, such as, for example, IFC data. In some examples, the particle classification system provides non-expert users with a straightforward data analysis tool to classify particles captured by imaging flow cytometry.

The described particle classification system integrates a non-linear dimensionality reduction step into the classification processing pipeline. As a result, the classification accuracy is improved as compared to a linear dimensionality reduction step. Moreover, the list of image features is not limited to morphometric and intensity measurements of imaged particles. For example, an embedding vector extracted from the provided AI-powered automated image analysis model can be added to this list of image parameters for further improving classification accuracy.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the instruments and combinations disclosed herein. These and other features of the present disclosure will become more fully apparent from the following description and appended claims or may be learned by the practice of the disclosure as set forth hereinafter.

### BRIEF DESCRIPTION OF THE DRAWINGS

Features and advantages of the present technology will become more apparent from the following detailed description of example embodiments thereof taken in conjunction with the accompanying drawings in which:

FIG. 1A depicts a chart showing quadrant gating of two flow fluorescence parameters used in particle labeling to create a training set, in accordance with one or more embodiments of the present disclosure.

FIG. 1B depicts representative images per label as used to create a training set, in accordance with one or more embodiments of the present disclosure.

FIG. 2A depicts a processing pipeline for particle classification, in accordance with one or more embodiments of the present disclosure.

FIG. 2B depicts an example list of image parameters for particle classification, in accordance with one or more embodiments of the present disclosure.

FIGS. 3A and 3B depict statistical results for particle classification, in accordance with one or more embodiments of the present disclosure.

FIG. 4 depicts a chart showing population statistics accuracy for particle classification shown in FIGS. 3A and 3B, in accordance with one or more embodiments of the present disclosure.

FIG. 5 depicts an example flowchart of a process for performing a training set creation by data clustering based on single user input, in accordance with one or more embodiments of the present disclosure.

FIG. 6 depicts image examples per cluster, in accordance with one or more embodiments of the present disclosure.

FIG. 7 depicts an example image parameter space where a particle similarity metric expressed in percentage is defined.

FIG. 8A depicts an example particle similarity application employed to produce a group of labeled images.

FIG. 8B depicts an example of a particle similarity confidence score from the data shown in FIG. 8A.

FIG. 8C shows another example of a particle similarity confidence score from another dataset that is less normally distributed.

FIGS. 9A and 9B depict single user input for training set data creation by clustering, in accordance with one or more embodiments of the present disclosure.

FIG. 10 depicts an AI-powered automated image analysis model, in accordance with one or more embodiments of the present disclosure.

FIGS. 11A and 11B depict spatial distribution discrepancy between training set data and test set data resulting from a separate nonlinear dimension reduction of each set, in accordance with one or more embodiments of the present disclosure.

FIG. 12 depicts a block diagram of various example components within an imaging system configured to perform one or more of the methods disclosed herein, in accordance with one or more embodiments of the present disclosure.

FIG. 13 depicts a flowchart of a method for providing classification parameters performed by the imaging system of FIG. 12, in accordance with one or more embodiments of the present disclosure.

While the present technology is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

Unless otherwise defined, all technical and scientific terms used herein have the same meaning as commonly understood by one of ordinary skill in the art. In case of conflict, the present document, including definitions, will control. Example methods and systems are described below, although methods and systems similar or equivalent to those described herein can be used in practice or testing of the present disclosure. All publications, patent applications, patents and other references mentioned herein are incorporated by reference in their entirety. The systems, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

In addition, unless otherwise indicated, numbers expressing quantities, constituents, distances, or other measurements used in the specification and claims are to be understood as being modified by the term “about.” The terms “about,” “approximately,” “substantially,” or their equivalents, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

The present disclosure is described with reference to the drawings, where like reference numerals are used to refer to like elements throughout. In the following description, for purposes of explanation, numbers of specific details are set forth in order to provide an improved understanding of the present disclosure. It may be evident, however, that the systems and methods of the present disclosure may be practiced without one or more of these specific details. In other instances, well-known structures and devices are shown in block diagram form to facilitate describing the systems and methods of the present disclosure. There is no specific requirement that a system, method, or technique relating to microscope image analysis include all of the details characterized herein to obtain some benefit according to the present disclosure. Thus, the specific examples characterized herein are meant to be example applications of the techniques described and alternatives are possible.

Current non-linear dimensionality reduction techniques (e.g., Uniform Manifold Approximation and Projection (UMAP), t-distributed Stochastic Neighbor Embedding (t-SNE), kernel principal component analysis (KernelPCA), Isometric Mapping (Isomap) embedding, and the like) are employed to reduce dimension of an existing data (e.g., from 30D to 2D) for visualization and hence cluster identification purposes. Due to their non-deterministic nature, such techniques are specific to certain domains and often require altering their algorithm and/or estimating a mapping function to insert new data points into the reduced dimension space of the existing data. A machine learning model may be trained from the reduced dimension space via, for example, a supervised approach where the trained model can then be applied to classify new data. For example, the trained model may be applied to the new data to rearrange the clustering; however, the results include completely new clusters that are not aligned with the clusters from the existing data and therefore not easy to compare. As another example, the trained model can be applied to new data to map new data points to an original parameter space. However, the mapping synchronizes the inherent variations between the two datasets and therefore, the mapping cannot handle cell variations, system variations, and inherent cell variations. Moreover, input for these models comes from the original space and not the reduced dimension one.

Accordingly, to address these and other issues, the systems and methods disclosed herein, which are generic and applicable to any data, adapt a trained model to process image data (e.g., imaging flow cytometry data) for particle classification while keeping discovered clusters when there are variations (e.g., cell perp, systemic inherent cell variations, and the like). Moreover, the systems and methods described herein relate to the international patent application PCT/US2021/055008 (Rognin et al., 2021) dated Oct. 14, 2021, describing an IFC data processing method for calculating image parameters, the entire content of which is incorporated by reference herein.

In some embodiments, the described particle classification system captures both flow fluorescence parameters with a marker and images of particles such as an image from a biological cell, where images are processed by a deep learning model to segment particles and derive image parameters. These parameters may include, for example, cell size, number of particles, pixel intensity-based parameters (e.g., average intensity), and the like. In this manner, particles can be classified based on image parameters where a training set is employed to label the data using fluorescence parameters or manually using the flow fluorescence parameters.

In some embodiments, the described particle classification system may be a part of a system that combines bright-field imaging and flow cytometry. In some embodiments, the system calculates image parameters using AI-powered automated image analysis. These image parameters include, for example, intensity, texture, shape, and object measurements. In some cases, the image parameters are used to characterize particle morphology at both cellular and sub-cellular levels.

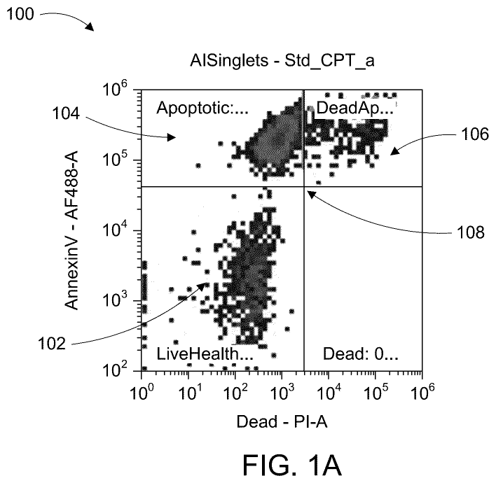

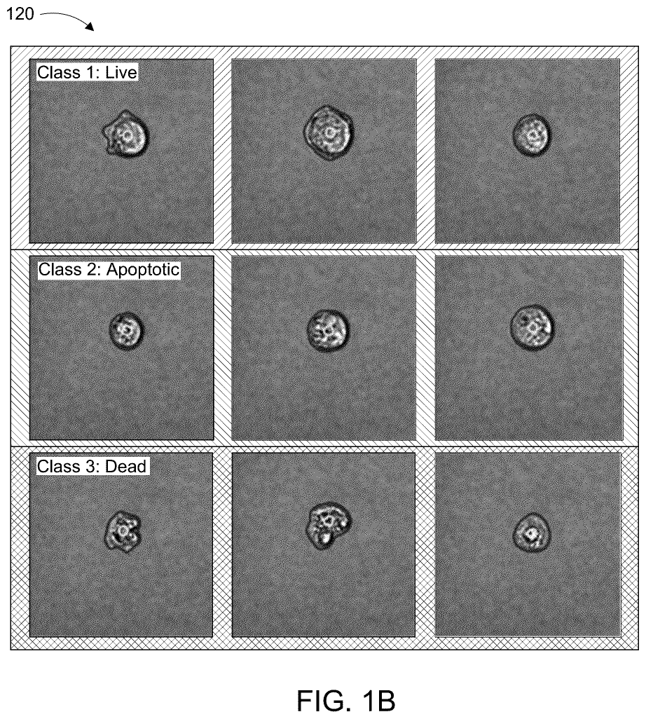

Generally, two approaches may be employed to characterize particle morphology using the image parameters: manual gating and clustering. As an example of the manual gating approach, a user selects relevant parameters and gates them to derive cell population statistics, such as the percentage of three classes of cell state: live, apoptotic, and dead (see FIGS. 1A and 1B). However, this manual process is often cumbersome, error-prone, and lacks inter-user reproducibility for non-expert users. The clustering approach, however, simplifies a workflow by avoiding these manual operations.

Accordingly, embodiments of the described system create a training set of particles, labeled by cellular staining, from a single user input, where each label type defines a particle class. In some embodiments, this training set is used to classify unlabeled particles based on only their image parameters. As a result, in such embodiments, the particle classification operation is performed without cellular staining. In some embodiments, the provided single user input, which is used to create a training set (labeled data), includes either gating flow fluorescence parameters (e.g., one label type per fluorescent maker or a combination of fluorescent markers) or a number of clusters to extract in a two-dimensional (2D) map resulting from the non-linear dimensionality reduction of normalized flow parameters and image parameters (e.g., one label type per cluster). In some cases, the training set is generated from data captured from a stained cells experiment acquired by, for example, a flow cytometer.

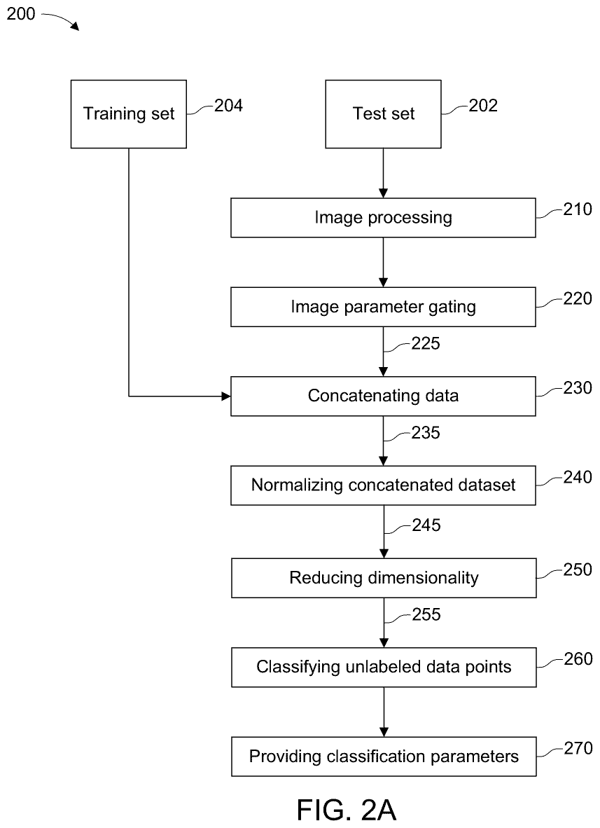

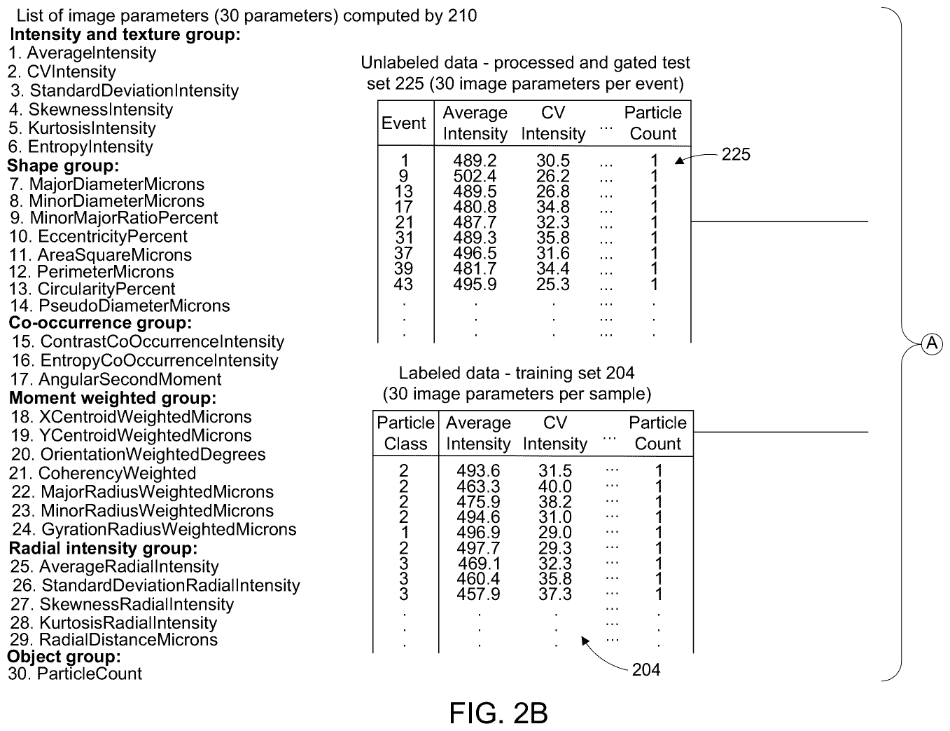

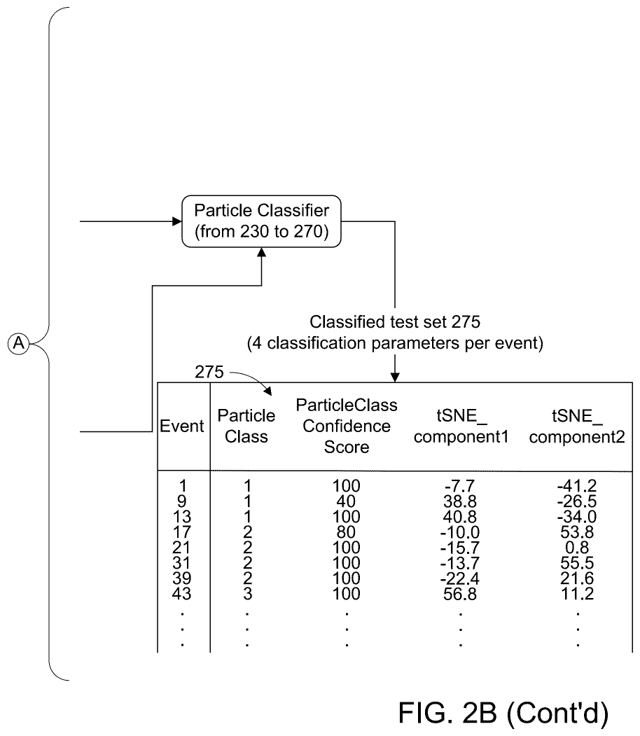

This method of creating a training dataset ensures a statistically significant number of training samples that would otherwise be unfeasible by manual sample selection by a user. In some embodiments, the described particle classification system employs dimensionality dimension reduction techniques, such as t-SNE and UMAP. Unlike Principal Component Analysis (PCA), which performs linear dimension reduction, t-SNE and UMAP are non-linear techniques that rely on iterative algorithms. Therefore, these dimensionality dimension reduction techniques (e.g., t-SNE and UMAP) are non-deterministic by nature and do not allow mapping new points from unlabeled data into the same reduced dimension space of labeled data. To address this issue, embodiments of the described particle classification system employ a classification processing pipeline (see FIG. 2A) that automatically adapts to unlabeled data.

In an example embodiment, a system particle classification system includes an imaging flow cytometer instrument configured to provide flow cytometry data and an electronic processing device. The electronic processing device is configured to: receive, from the imaging flow cytometer instrument, a test set of images comprising unlabeled data to classify; process the test set to obtain the image parameters; gates the processed test set; pool the gated processed test set and a training set, which includes labeled data, into a concatenated dataset that includes a plurality of parameters; normalize the concatenated dataset by bringing the variance to one for each of the plurality of parameters; non-linearly reduce a dimensionality of the normalized concatenated dataset to a reduced dimension space; compute classification parameters by classifying the unlabeled data from the reduced dimension space using the labeled data from the reduced dimension space; and provide the classification parameters for further processing. Although some embodiments are described herein with respect to analyzing imaging flow cytometry (IFC) data, the systems and methods described herein for analyzing particles can be used to analyze particle data originating from other techniques and, thus, embodiments described herein are not limited to IFC data.

FIGS. 1A and 1B depict information that can be used for particle classification with single user input for training dataset creation by gating of two flow fluorescent parameters. The 2D map 100 depicted in FIG. 1A shows a training dataset that represents image samples with, as an example, two flow fluorescence parameters, Annexin V and Propidium Iodide (PI) cellular staining. The quadrants are defined according to a quadrant gate 108, which can be defined by a user. The map 100 includes a quadrant for live cells 102, apoptotic cells 104, and dead cells 106. Generally, for each image event number (class (1) life, (2) apoptotic (2), (3) dead), a classification confidence score, and the XY coordinates of the nonlinear dimensionality reduction output are provided such that the user can visualize how the data was classified. FIG. 1B depicts representative images per label 120. The training dataset may be employed for automatic training dataset labeling into three classes by user quadrant gating of a density plot, where each quadrant defines a class of images.

In some examples, a training dataset includes data with a sample vector that may be stored to a datastore. In some embodiments, the sample vector includes a list of the image parameters. Moreover, in some embodiments, a class is associated with each sample based on user input (e.g., manual gating).

### Processing Pipeline

FIG. 2A depicts a processing pipeline 200 for particle classification. The processing pipeline 200 includes a test set 202 that includes unlabeled data and represents the data to classify, and a training set 204 that includes labeled data. In the specific example described below, the test set 202 includes images, where each image is associated with an event (e.g., a unique number). Generally, the processing pipeline 200 aligns the test set 202 and the training set 204 so that a classification can be applied. As depicted, the processing pipeline 200 uses nonlinear dimensionality reduction to classify unlabeled data and output classification parameters. The processing pipeline 200 is compatible with state-of-art and future non-linear dimensionality reduction techniques without requiring changes to their algorithm and/or approximating a mapping function to insert unlabeled data points into the reduced dimension space. Moreover, users may employ processing pipeline 200 to add a new sample in the 2D reduce space without having to modify the algorithm or create a specific mapping function (e.g., a trained neural network).

At 210, the test set 202 is processed to obtain the image parameters per event. For example, image parameters per event result from processing the test set 202 with the same image processing model (e.g., a deep learning image segmentation model) as the one used to compute image parameters in the training set. In some embodiments, the number of image parameters is typically 30 as shown in Table 1 below.

From 210, the processing pipeline 200 proceeds to 220 where image parameters gating is optionally applied to extract singlet events. Generally, a singlet represents one particle in the field of view. From 220, the processing pipeline 200 proceeds to 230 where labeled data of image parameters per training sample and unlabeled data of image parameters per event are concatenated into a concatenated dataset 235 (the output of 230) by pooling the gated processed test set 225 (the output of 220) and the training set 204. From 230, the processing pipeline 200 proceeds to 240 where the concatenated dataset is normalized. In some embodiments, the z-score method is applied to normalize the concatenated dataset. For example, the z-score method forces the average to zero and standard deviation to one for each parameter (e.g., each column in the table) in the concatenated dataset.

From 240, the processing pipeline 200 proceeds to 250 where dimensionality of the normalized concatenated data space 245 (e.g., 30 dimensions correlates to 30 image parameters) is non-linearly reduced to obtain a reduced dimension space (e.g., 30 dimensions reduced into 2 dimensions). Importantly, applying the dimensional reduction on the sets individually (e.g., the gated processed test set 225 and the training set 204) instead of the normalized concatenated data 245 (the output of 240) would result in a misalignment between the reduced space because the nonlinear dimensional reduction techniques are nondeterministic unlike linear methods such as PCA.

From 250, the processing pipeline 200 proceeds to 260 where unlabeled data points in the reduced dimension space are classified using labeled data points into the same space. For example, the class of a given unlabeled data point is determined using a k-nearest neighbors (k-NN) classifier by the majority vote of the k nearest labeled data points with respect to the given unlabeled data point in the reduced dimension space 255, where k is generally set at 5.

Generally, steps 230 and 240 enable the auto-adaptiveness to unlabeled data by ensuring spatial location consistency between labeled and unlabeled data points in the same reduced dimension space 255 (the output of 250) used by, for example, a k-NN algorithm to classify unlabeled data. These results provide for a global analysis of the data that takes statistics at a global level. To state another way, data concatenation 230 followed by parameter values normalization 240 uniformizes the data for the nonlinear dimensionality reduction 250 for the classification task 260. Moreover, normalizing these sets individually would degrade the classification accuracy.

From 260, the processing pipeline 200 proceeds to 270 where classification parameters per unlabeled data point (particle class, confidence score, and coordinates in reduced dimension space) are provided as output in the form of a classified test set 275 as shown in FIG. 2B.

TABLE 1
List of Image Parameters
Intensity and Texture Group:

| | |
|---|---|
| 1. | Average Intensity |
| 2. | CV Intensity |
| 3. | Standard Deviation Intensity |
| 4. | Skewness Intensity |
| 5. | Kurtosis Intensity |
| 6. | Entropy Intensity |

Share Group:

| | |
|---|---|
| 7. | Major Diameter (micrometers) |
| 8. | Minor Diameter (micrometers) |
| 9. | Minor Major Ratio (percent) |
| 10. | Eccentricity (percent) |
| 11. | Area Square (micrometers) |
| 12. | Perimeter (micrometers) |
| 13. | Circularity (percent) |
| 14. | Pseudo Diameter (micrometers) |

Co-occurrence Group:

| | |
|---|---|
| 15. | Contrast Co-occurrence Intensity |
| 16. | Entropy Co-Occurrence Intensity |
| 17. | Angular Second Moment |

Moment Weighted Group:

| | |
|---|---|
| 18. | X Centroid Weighted (micrometers) |
| 19. | Y Centroid Weighted (micrometers) |
| 20. | Orientation Weighted (degrees) |
| 21. | Coherency Weighted |
| 22. | Major Radius Weighted (micrometers) |
| 23. | Minor Radius Weighted (micrometers) |
| 24. | Gyration Radius Weighted (micrometers) |

Radial Intensity Group:

| | |
|---|---|
| 25. | Average Radial Intensity |
| 26. | Standard Deviation Radial Intensity |
| 27. | Skewness Radial Intensity |
| 28. | Kurtosis Radial Intensity |
| 30. | Radial Distance (micrometers) |

Object Group:

| | |
|---|---|
| 31. | Particle Count |

### Example Data

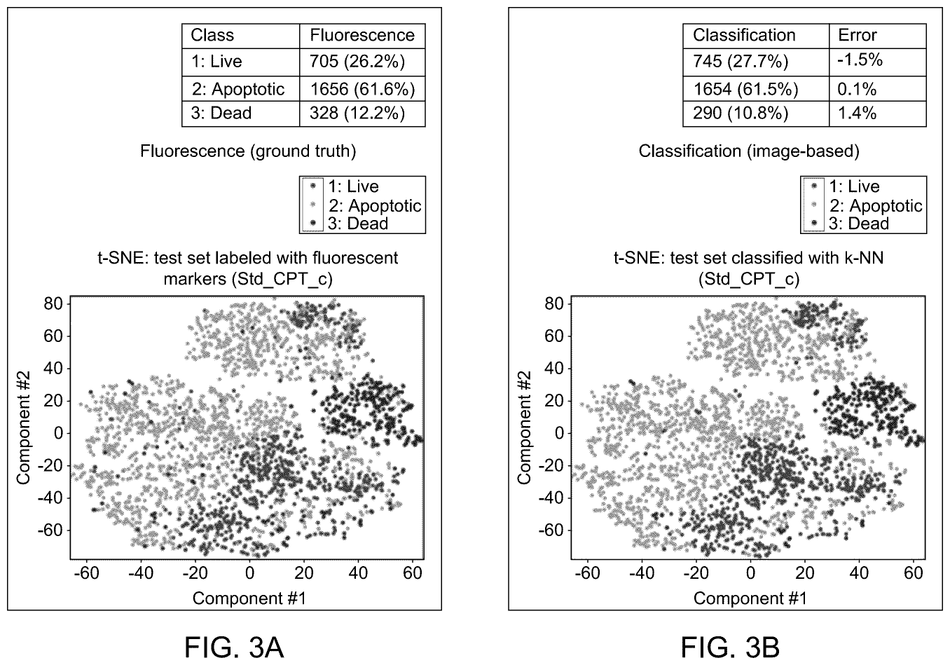

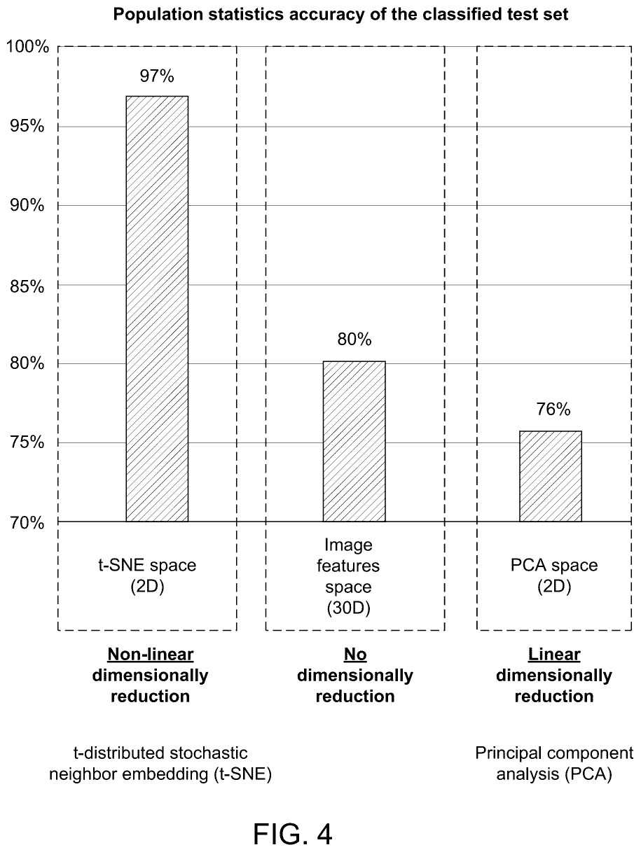

FIGS. 3A, 3B, and 4 depict statistical results for particle classification. FIG. 3A depicts a chart showing the results of a test set labeled with fluorescent markers (ground truth). FIG. 3B depicts a chart showing the results of a test set classified with the k-NN algorithm (for k=5) applied to the reduced dimension space outputted by t-SNE non-linear dimensionality technique. FIG. 4 depicts a chart showing the population statistics accuracy of the classified test set, which is defined as 100% minus the sum of absolute error per class reported in FIG. 3B: 100%−(|−1.5%|+|0.1%|+|1.4|%)=97%. FIGS. 3A, 3B, and 4 show the advantage of nonlinear dimensionality reduction, such as employed by the described system (t-SNE), over other methods. In one example, directly applying classification on the row image parameters space drops the population statistics accuracy from 97% to 80%. Moreover, in another example, a nonlinear classification outperforms a linear classification when applying a linear dimensionality reduction technique, such as PCA. Moreover, the results depicted in FIGS. 3A, 3B, and 4 show that accuracy and overall system performance is increased by applying a classification by using nonlinear dimension reduction without the need of modifying the algorithm or creating a specific mapping (because of the concatenation step 230 described with reference to FIG. 2A).

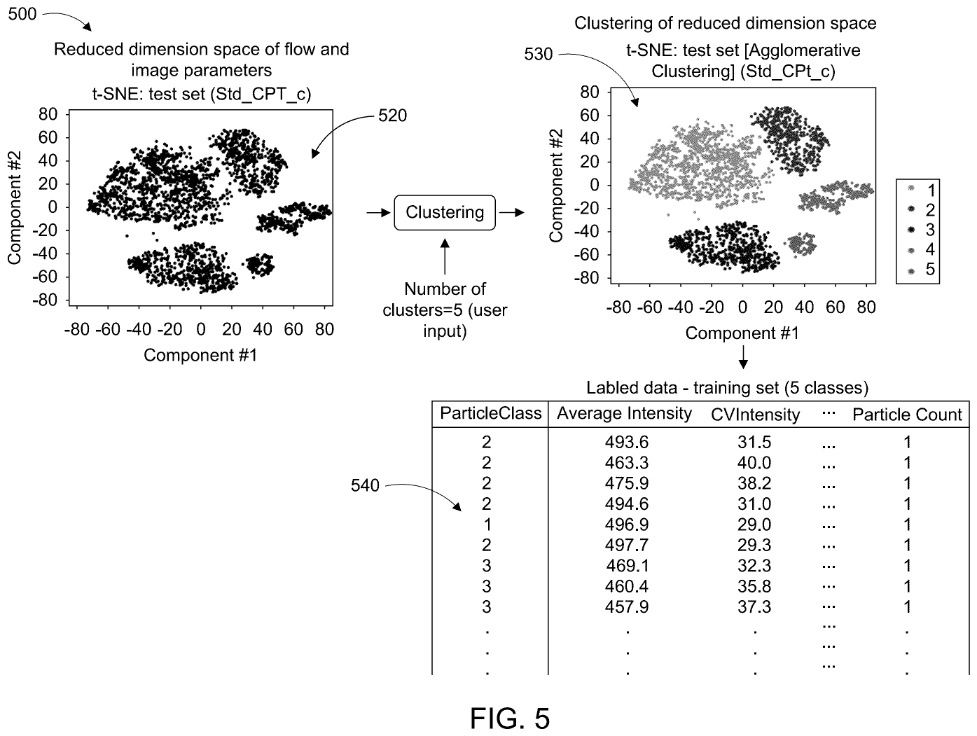

FIG. 5 depicts an example flowchart of a process 500 of a single user input for training set creation by data clustering. The 2D map 520 is obtained by applying nonlinear dimensionality reduction (t-SNE) to a data set containing both flow and image parameters. A clustering algorithm is applied to the 2D map 520 to generate the clustering map 530. The depicted technique employs an agglomerative clustering algorithm, where the user inputs the number of clusters; however, other algorithms (e.g., k-means with k=5) may also be used. The clustering map 530 shows five clusters as an example; however, any number of clusters may be determined from visual inspection of 520. The clusters in the clustering map 530 are then used as labels (one label per class) to create a training set 540, which may then be used as the training set 204 described above with reference to FIG. 2A.

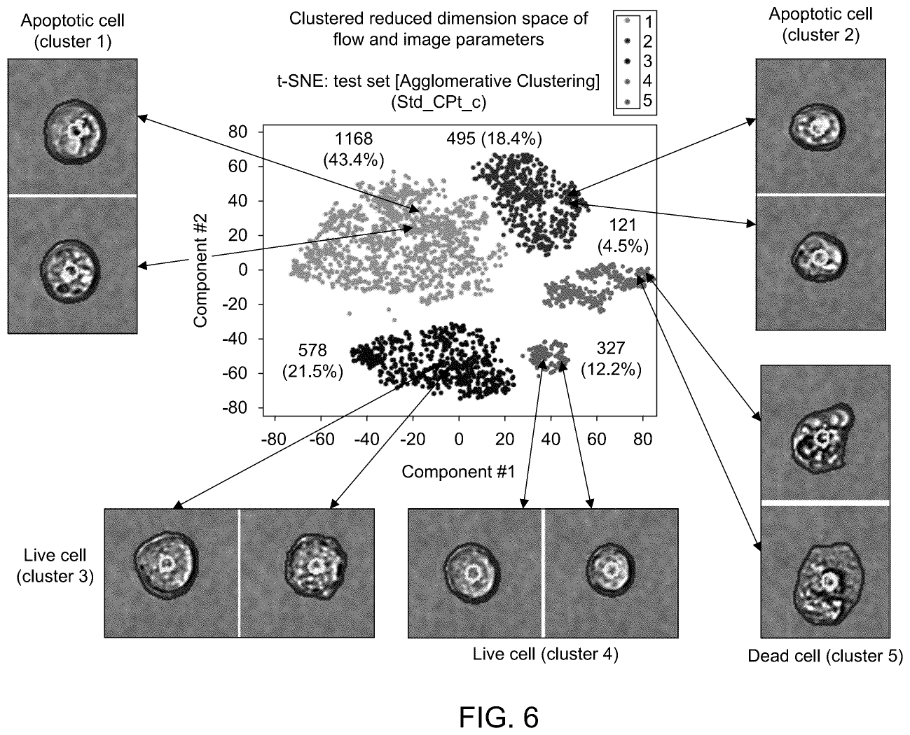

FIG. 6 depicts image examples per cluster highlighting morphological differences between particles to demonstrate the relevance of creating a training set via data clustering 530. The number of image samples and related percentage are reported next to each cluster in the 2D plot. For instance, the apoptotic cell cluster number 1 comprises 1168 image events representing 43.4% of the 2689 total number of image events. This example of data clustering shows that two types of apoptotic cell (cluster number 1 and 2), two types of live cell (cluster number 3 and 4), and a single type of dead cell (cluster number 5) are identified. In particular for the two types of live cell, the morphological differences highlight a higher spatial frequency content in image examples of cluster number 3 than the ones of cluster number 4. Such refinement in the number of classes for the training set creation (one class per cluster) cannot be reflected by the manual quadrant gating 108 of FIG. 1A for which only three classes are identifiable (live cell, apoptotic cell, and dead cell) according to the representative images per class shown in FIG. 1B. This demonstrates the added value of training set creation via data clustering for refining the number of classes.

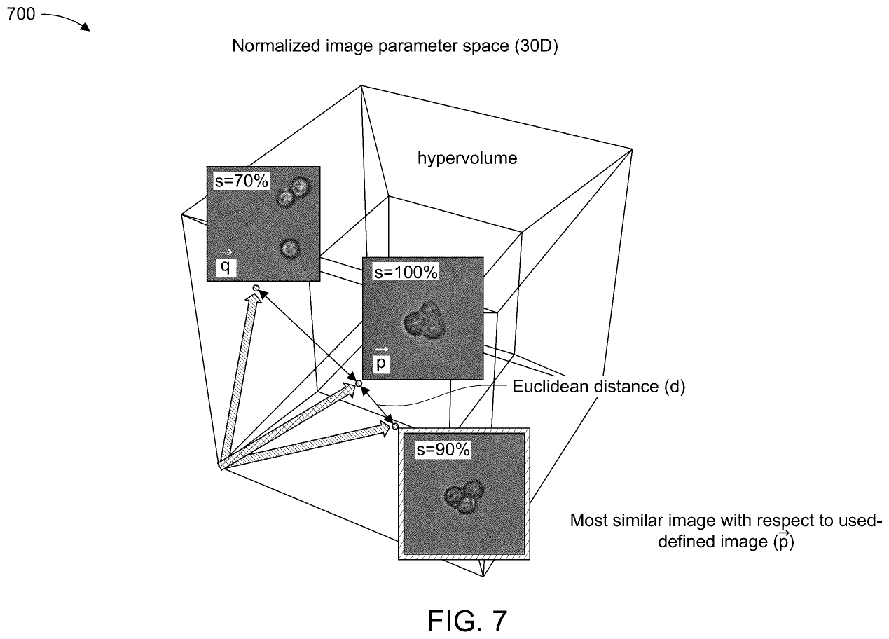

FIG. 7 depicts an example image parameter space 700 where a particle similarity metric expressed in percentage is defined. In some embodiments, the Euclidean distance in the image parameter space is defined according to:

$$d ( \vec{p} , \vec{q} ) = \sqrt{{\sum }_{i = 1}^{N} {( {p}_{i} - {q}_{i} )}^{2}}$$

where \vec{p},\vec{q}: are two points in the normalized image parameter space, N is the dimension of the normalized image parameter space (e.g., N=30). Alternatively, each image parameter can be weighted according to a feature ranking analysis. In some embodiments, the particle similarity metric expressed in percentage is according to:

$$s ( \vec{p} , \vec{q} ) = 100 \times ( 1 - \frac{d ( \vec{p} , \vec{q} )}{d ( - \vec{2 σ} , + \vec{2 σ} )} )$$

where s(\vec{p},\vec{q}) is particle similarity (%), σ is the standard deviation, and d(−\vec{2σ}, +\vec{2σ}) is the farthest distance covering a 95% confidence interval (2σ) assuming normally distributed data. In some cases, the confidence score of a particle similarity metric is defined as the goodness-of-fit given by the fitting of a Gaussian probability density function to the normalized histogram of particle similarity metric. The percentage of similarity per image can be thresholded to associate all images above a predetermined threshold (e.g., all images greater than 80%) with the unique particle class.

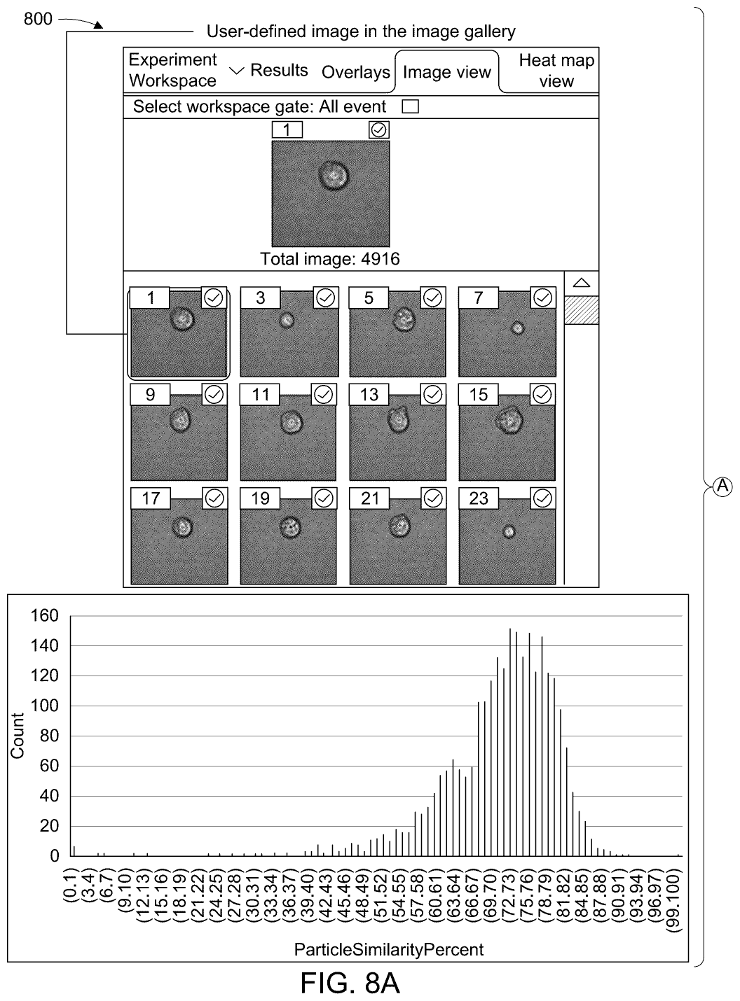

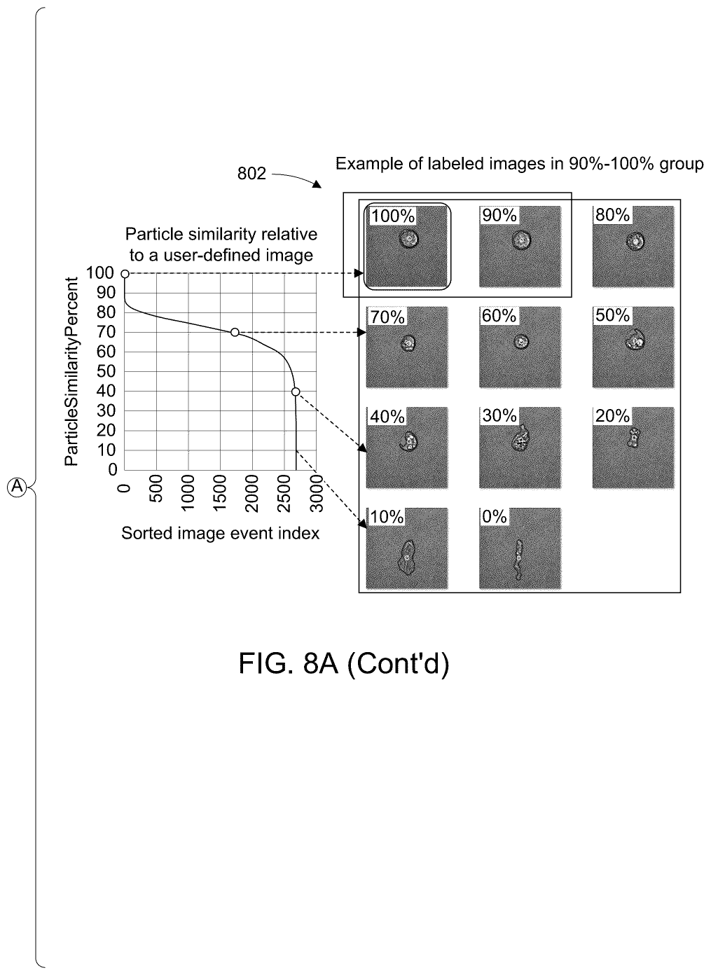

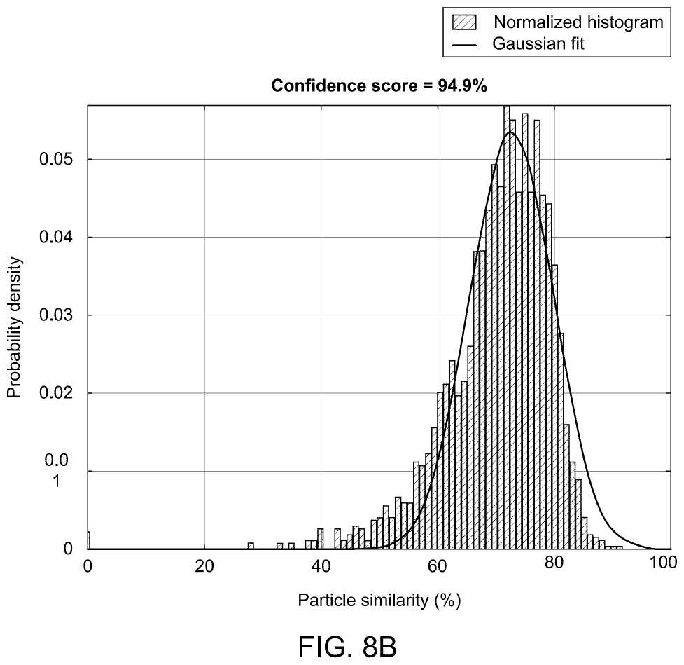

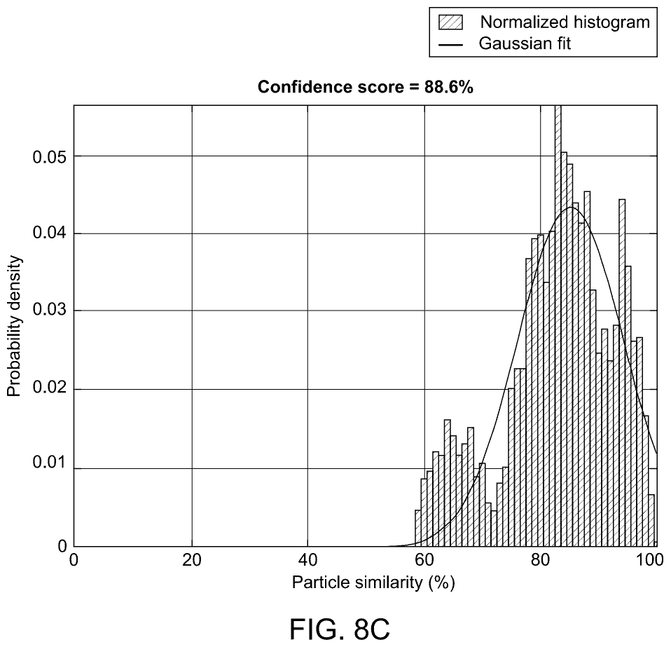

FIG. 8A depicts an example particle similarity application 800 employed to produce a group of labeled images 802. In some embodiments, the application 800 employs a classifier model that includes a training set used to classify a dataset of unlabeled particles based on their image parameters. As a result, the particle classification operation is performed without any cellular staining. In some cases, the training set is generated by attributing a particle class number per group of images from a collection of user-selected samples that are pre-processed with a base model to produce image parameters.

As described above, three possible image labeling techniques may be employed by the described system: supervised learning (see FIGS. 1A and 1B), unsupervised learning (see FIG. 5), and semi-supervised learning (see FIGS. 7 and 8A). In some embodiments, supervised learning includes manual gating of flow parameters, where each gate (or combination of gates) is a group of images. In such a context, cellular staining can be used as a ground truth. In some embodiments, unsupervised learning groups images by data clustering of flow and/or image parameters where each cluster is a particle class number. In some embodiments, semi-supervised learning includes grouping images by similarity with respect to a user-defined single image per particle class number. In some cases, such a technique is intuitive for the user and the fastest in terms of data processing.

FIGS. 8B and 8C depict examples of particle similarity confidence score. FIG. 8B shows a first example of particle similarity confidence score of 94.9% from the data shown in FIG. 8A. FIG. 8C shows a second example of a particle similarity confidence score of 88.6% from another dataset that is less normally distributed.

In some implementations, to measure data normalcy distribution, a particle similarity confidence score is calculated from the goodness-of-fit resulting from fitting of a Gaussian function [symbol] ₛ to the normalized histogram of particle similarity hₛ with a binning of 1. The Gaussian function, which is the probability density function of the normal distribution, is defined as:

$${𝒩}_{s} = A \frac{1}{ρ \sqrt{2 π}} {e}^{- \frac{{( s - μ )}^{2}}{2 {ρ}^{2}}}$$

where s: dependent variable (particle similarity); A: area under the curve parameter; μ: mean parameter; and ρ: standard deviation parameter. The particle similarity confidence score k is defined by the coefficient of determination expressed in percentage as follows:

$$κ = 100 \times ( 1 - \frac{RSS}{TSS} )$$

where RSS: residual sum of squares, RSS=Σₛ₌₀¹⁰⁰(hₛ− [symbol] ₛ)²; and TSS: total sum of squares, TSS=Σₛ₌₀¹⁰⁰(hₛ−h̅)² with

$$\overline{h} = \frac{1}{101} {\sum }_{s = 0}^{100} {h}_{s}$$

Alternatively, a confidence score per image parameter can be calculated from the normalized histogram of each image parameter. A global confidence score can be calculated as the average of all confidence scores per image parameter.

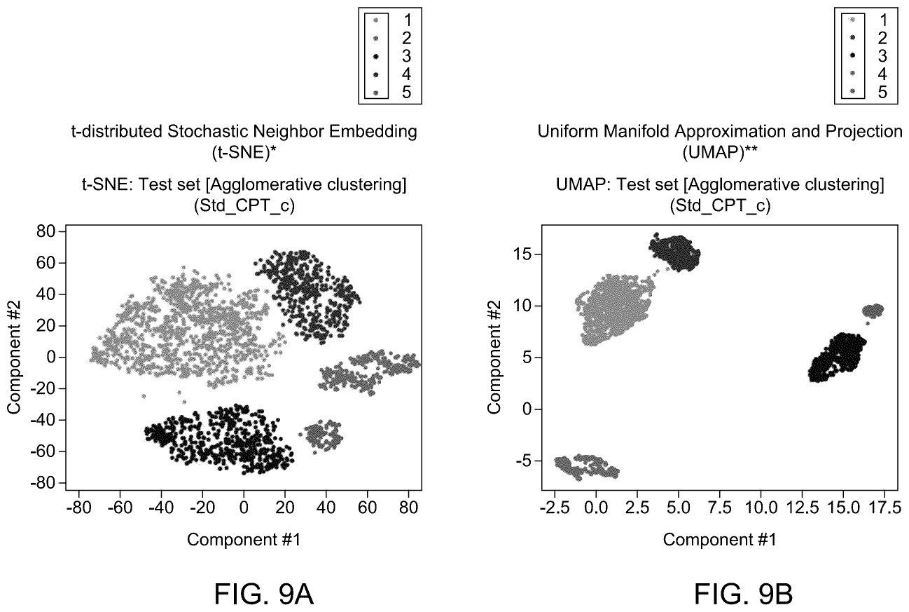

FIGS. 9A and 9B depict single user input (number of clusters) for training set creation by clustering (the step 250 described with reference to FIG. 2A). FIG. 9A depicts a 2D map, resulting from the t-SNE nonlinear dimensionality reduction of a data set containing both flow and image parameters, where clusters were identified by the agglomerative clustering algorithms. FIG. 9B depicts a 2D map resulting from the UMAP nonlinear dimensionality reduction of a data set containing both flow and image parameters, where clusters were identified by the agglomerative clustering algorithms. The UMAP version is preferable as it exhibits a better spatial separation of clusters than the t-SNE version.

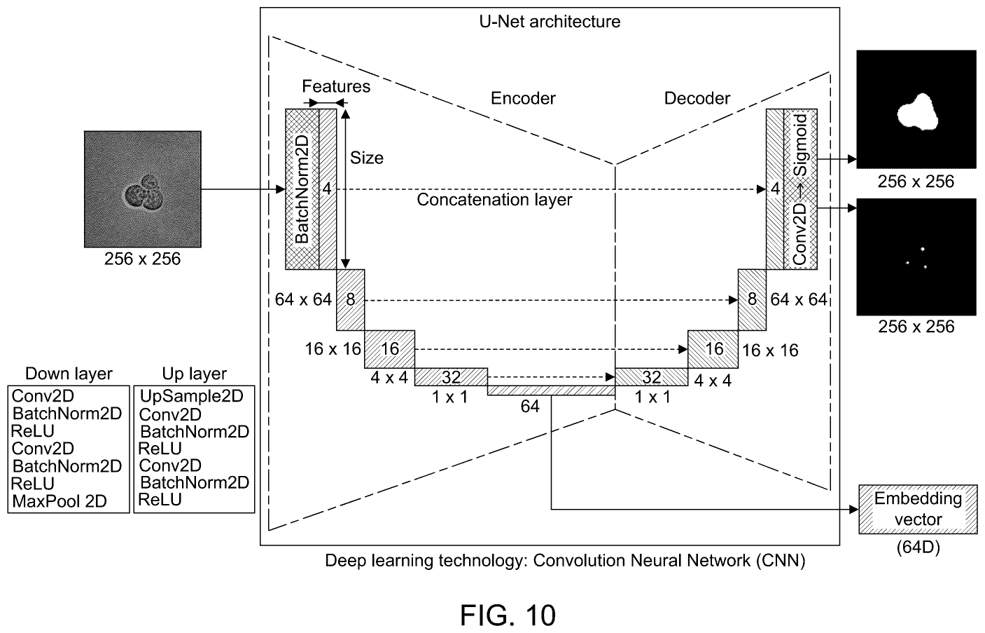

FIG. 10 depicts an AI-powered automated image analysis model. An embedding vector containing 64 parameters, extracted from this model can be added to the list image parameters of, for example, Table 1 for further improving classification accuracy, such that the number of image parameters is expanded from 30 to 94 (30 current image parameters plus 64 parameters from the embedding vector).

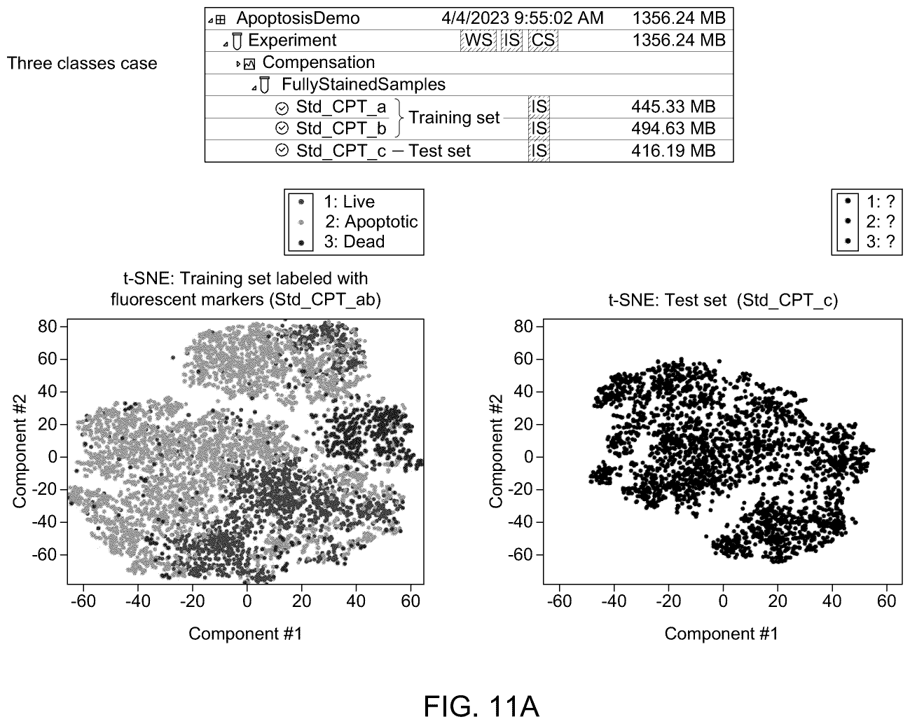

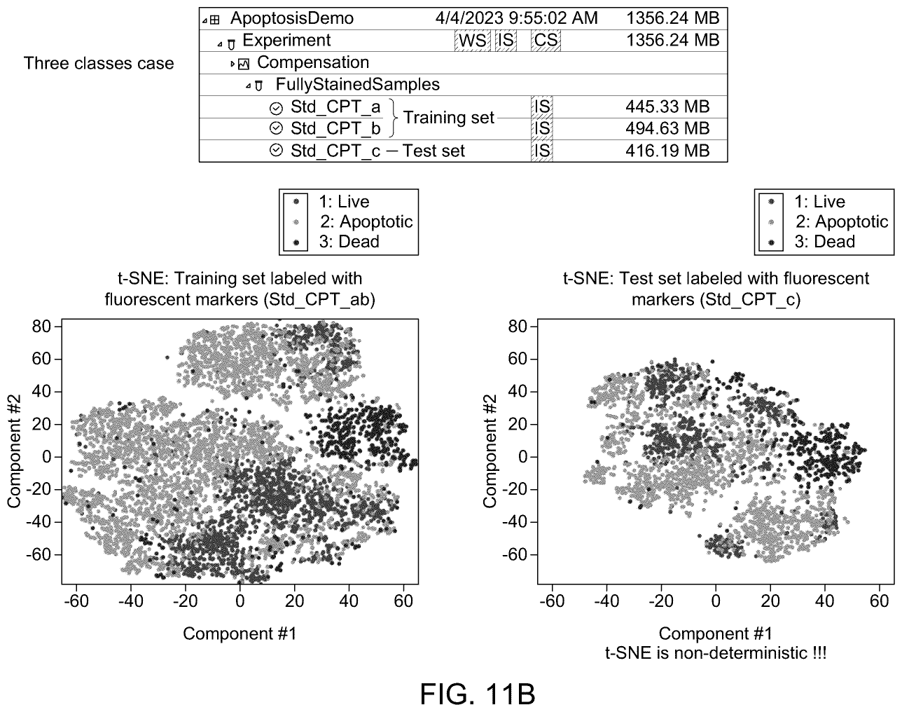

FIGS. 11A and 11B depict results of particle classification where samples A and B are used to create a training set (labeled data) and sample C is used for the test set (unlabeled data). The depicted results show that the spatial distribution samples between the training dataset and the test set is inconsistent for performing classification. Whereas, when the two sets are combined and then the parameters normalization, spatial consistency between the two sets is created for which classification may then be applied.

### Example Imaging System

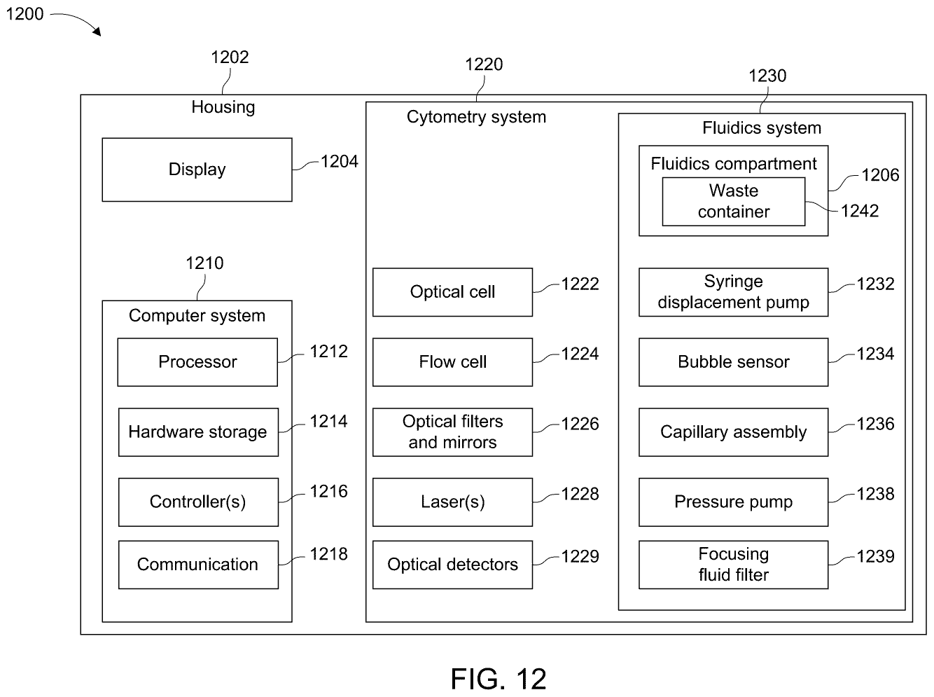

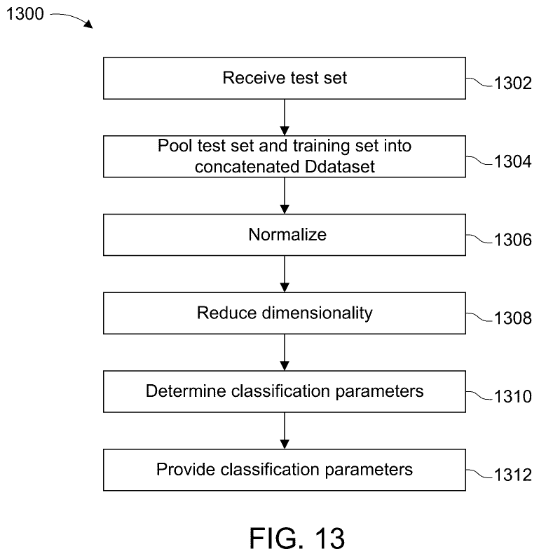

FIG. 12 is a schematic of various example components within an imaging system 1200, in accordance with one or more embodiments of the present disclosure. The imaging system 1200 is configurable to perform one or more of the methods disclosed herein. For example, the imaging system 1200 is operable to facilitate the method associated with the processing pipeline 200, the process 500, and the process 1300 (see the description of FIG. 13 below). The imaging system 1200 includes a housing 1202, which encloses and protects the optics and computing systems used for IFC.

As illustrated in FIG. 12, the imaging system 1200 includes a computer system 1210 and a cytometry system 1220 included therewith. FIG. 12 conceptually represents the computer system 1210 and the cytometry system 1220 as disposed within the housing 1202 of the imaging system 1200. However, one will appreciate, in view of the present disclosure, that any portion of the computer system 1210 or the cytometry system 1220 may be disposed at least partially outside of the housing 1202 within the scope of the disclosed embodiments.

FIG. 12 shows that the computer system 1210 of the imaging system 1200 can comprise various components, such as electronic processor(s) 1212 (also “central processing Unit” (CPU), “electronic processor,” and “computer processor” herein), hardware storage device(s) 1214, controller(s) 1216, and communications module(s) 1218.

The electronic processor(s) 1212 may comprise one or more sets of electronic circuitry that include any number of logic units, registers, and/or control units to facilitate the execution of computer-readable instructions (e.g., instructions that form a computer program). Such computer-readable instructions may be stored within the hardware storage device(s) 1214, which may comprise physical system memory and which may be volatile, non-volatile, or some combination thereof.

The controller(s) 1216 may comprise any suitable software components (e.g., set of computer-executable instructions) and/or hardware components (e.g., an application-specific integrated circuit, or other special-purpose hardware component(s)) operable to control one or more physical apparatuses of the imaging system 1200, such as portions of the cytometry system 1220.

The communication module(s) 1218 may comprise any combination of software or hardware components that are operable to facilitate communication between on-system components/devices and/or with off-system components/devices. For example, the communications module(s) 1218 may comprise ports, buses, or other physical connection apparatuses for communicating with other devices (e.g., USB port, SD card reader, and/or other apparatus). Additionally, or alternatively, the communications module(s) 1218 may comprise systems operable to communicate wirelessly with external systems and/or devices through any suitable communication channel(s), such as, by way of non-limiting example, Bluetooth, ultra-wideband, WLAN, infrared communication, and/or others.

As shown in FIG. 12, the imaging system 1200 includes a cytometry system 1220 having an optical cell 1222, a flow cell 1224, optical filters and mirrors 1226, multiple lasers 1228, optical detectors 1229, and a fluidics system 1230. The fluidics system 1230 includes a syringe displacement pump 1232, a bubble sensor 1234, a capillary assembly 1236, a pressure pump 1238, and a focusing fluid filter 1239.

The cytometry system 1220 may use acoustic pressure to confine injected particles to a tight central line as a sample passes through the optical cell 1222 for interrogation. Acoustic focusing places the interrogated particles within a narrow depth-of-field, which allows the production of in-focus images at standard flow cytometry rates.

In some embodiments, a sample is loaded into the cytometry system 1220 via the sample injection port 1208. The sample is delivered to the flow cell 1224 after a user defines collection criteria. The sample is pushed through the capillary assembly 1236 and wrapped in a sheath of focusing fluid before it is intercepted by the laser beam for interrogation. In some embodiments, the capillary assembly 1236 is an acoustic resonant device that focuses cells or particles into a single, tight line using a capillary coupled to a piezoelectric transducer.

As the sample traverses an interrogation point, the cytometry system 1220 uses the lasers 1228 to illuminate the particles or cells in the sample, which scatter the laser light and emit fluorescent light from fluorescent dyes attached to them. The optical filters and mirrors 1226 route specified wavelengths of the resulting light scatter and fluorescence signals to the designated optical detectors 1229 (e.g., PMT detectors and a diode detector (FSC)).

The optical detectors 1229 convert the fluorescence signals and collected light scatter into electrical signals (i.e., voltage pulses), which are proportional to the intensity of the light received by the detectors. The electrical signals are provided to the computer system 1210 for further processing.

The fluidics system 1230 handles the flow of fluids including the fluid functions during data collection. In some cases, the sample to be analyzed is driven by the syringe displacement pump 1232 and passes through the bubble sensor 1234 along the path of the sample loop before arriving at the capillary assembly 1236. The continuous flow pressure pump 1238 controls the focusing fluid through the focusing fluid filter 1239 and combines it with the sample fluid to allow for particle hydrodynamic focusing.

In some embodiments, the capillary assembly 1236 is an acoustic resonant device that focuses cells or particles in the sample fluid into a single tight line (i.e., the sample core) using a capillary coupled to a single piezoelectric transducer. The capillary carries the sample core upward through the center of the optical cell, where the particles to be analyzed are intercepted by a tightly-focused laser beam for interrogation. After passing through the optical cell, the stream arrives at a waste container 1242 (included in the fluidics compartment 1206).

FIG. 12 furthermore illustrates that, in some instances, the imaging system 1200 includes a display 1204. The display 1204 may be in communication, whether directly or indirectly, with various other components of the imaging system 1200, such as the computer system 1210 or the cytometry system 1220 thereof. For example, the imaging system 1200 may capture images using components of the cytometry system 1220, and captured images may be processed and/or stored using components of the computer system 1210 (e.g., processor(s) 1212, hardware storage device(s) 1214, etc.), and the processed and/or stored images may be displayed on the display 1204 for observation by one or more users.

As described herein, the components of the imaging system 1200 may adapt a trained model to process an imaging dataset for particle classification while keeping discovered clusters when there are variations. Moreover, one will appreciate, in view of the present disclosure, that an imaging system may comprise additional or alternative components relative to those shown and described with reference to FIG. 12, and that such components may be organized and/or distributed in various manners.

### Example Process

FIG. 13 depicts a flowchart of an example process 1300. The example process 1300 generally shows in more detail how classification parameters are determined from a test set. For clarity of presentation, the description that follows generally describes the example process 1300 in the context of FIGS. 1-12. For example, the example process 1300 can be implemented by the components of the example imaging system 1200 described above with respect to FIG. 12. However, it will be understood that the process 1300 may be performed, for example, by any other suitable system, environment, software, and hardware, or a combination of systems, environments, software, and hardware as appropriate. In some embodiments, various operations of the process 1300 can be run in parallel, in combination, in loops, or in any order.

At 1302, a test set comprising unlabeled data to classify is received. From 1302, the process 1300 proceeds to 1304 where the test set and a training set, which includes labeled data, is pooled into a concatenated dataset. The concatenated dataset includes a plurality of parameters. In some embodiments, a plurality of image parameters is determined by processing the test set through an image processing model. In some embodiments, singlets are extracted by applying image feature gates to the plurality of image parameters. In some embodiments, the image processing model includes a classifier model selected by a user. In some embodiments, the plurality of image parameters includes flow parameters or fluorescence parameters. In some embodiments, the plurality of image parameters includes cell size, a number of particles, or pixel intensity-based parameters. In some embodiments, the test set and the training data each include flow cytometry data.

In some embodiments, before pooling the test set and a training set into a concatenated dataset, the training set is created by generating a 2D map by applying a dimensionality reduction technique to a normalized data set comprising flow parameters, or image parameters, or flow and image parameters. In some embodiments, a clustering map comprising a plurality of clusters is generated by applying a clustering algorithm to the 2D map. In some embodiments, the labeled data comprises the plurality of clusters. In some embodiments, each of the plurality of clusters corresponds to a class determined according to user input.

In some embodiments, the dimensionality reduction technique comprises a nonlinear dimensionality reduction technique or a linear dimensionality reduction technique. In some embodiments, the linear dimensionality reduction technique is random projection or PCA. In some embodiments, the nonlinear dimensionality reduction technique is KernelPCA, Isomap embedding, UMAP, or t-SNE. In some embodiments, the normalized concatenated dataset is reduced to the reduced dimension space using the same dimensionality reduction technique as applied to the normalized data set (used to generate the training set). In some embodiments, the normalized concatenated dataset is reduced to the reduced dimension space using a different dimensionality reduction technique than the dimensionality reduction technique applied to the normalized data set (used to generate the training set).

In some embodiments, the clustering algorithm is an agglomerative clustering algorithm, a k-means clustering algorithm, a spectral clustering algorithm, a mean-shift clustering algorithm, or a Density-Based Spatial Clustering of Applications with Noise (DBSCAN) clustering algorithm. In some embodiments, the test set is generated from a stained cells experiment acquired by a flow cytometer.

From 1304, the process 1300 proceeds to 1306 where the concatenated dataset is normalized by bringing the variance to one for each of the plurality of parameters. In some embodiments, the concatenated dataset is normalized by applying the z-score method. In some embodiments, the normalized concatenated dataset provides spatial location consistency between the labeled data and the unlabeled data in a same reduced dimension space.

From 1306, the process 1300 proceeds to 1308 where a dimensionality of the normalized concatenated dataset is non-linearly reduced to a reduced dimension space.

From 1308, the process 1300 proceeds to 1310 classification parameters are computed by classifying the unlabeled data from the reduced dimension space using the labeled data from the reduced dimension space. In some embodiments, the unlabeled data is classified using a k-NN classifier. In some embodiments, the classification parameters include a particle class, a confidence score, or coordinates in the reduced dimension space.

From 1310, the process 1300 proceeds to 1312 where the classification parameters are provided for further processing. In some embodiments, the further processing includes population statistics analysis of classified particles. For example, the further processing can include determining and analyzing a plurality of population statistics. The plurality of population statistics can include a percentage of live, apoptotic, and dead cells. Alternatively or in addition, the plurality of population statistics can include a percentage of different degree of cell response to a given therapy or a panel of therapies. From 1312, the process 1300 ends.

One will appreciate, in view of the present disclosure, that the principles described herein may be implemented utilizing any suitable imaging system and/or any suitable imaging modality. The specific examples of imaging systems and imaging modalities discussed herein are provided by way of example and as a means of describing the features of the disclosed embodiments. Thus, the embodiments disclosed herein are not limited to any particular cytometry system or cytometry application and may be implemented in various contexts, such as brightfield imaging, fluorescence microscopy, flow cytometry, confocal imaging (e.g., 3D confocal imaging, or any type of 3D imaging), and/or others. For example, principles discussed herein may be implemented with flow cytometry systems to provide particle classification while keeping discovered clusters when there are variations.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computer. In further embodiments, a computer readable storage medium is a tangible component of a computer. In some embodiments, a computer readable storage medium is optionally removable from a computer. In some embodiments, a computer readable storage medium includes, by way of non-limiting examples, compact disc read-only memories (CD-ROMs), digital versatile discs (DVDs), flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in an electronic processor (e.g., the electronic processor 1012) of the computer, written to perform a specified task. Computer readable instructions may be implemented as program modules, such as functions, objects, application programming interface (API), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Machine Learning

In some embodiments, machine learning algorithms are employed to build a model to classify particles based on a dataset(s). Examples of machine learning algorithms may include a support vector machine (SVM), a naïve Bayes classification, a random forest, a neural network, deep learning, or other supervised learning algorithm or unsupervised learning algorithm for classification and regression. The machine learning algorithms may be trained using one or more training datasets. For example, previously received location or user data may be employed to train various algorithms. Moreover, as described above, these algorithms can be continuously trained/retrained using real-time user data as it is received. In some embodiments, the machine learning algorithm employs regression modeling where relationships between variables are determined and weighted. In some embodiments, the machine learning algorithm employs regression modeling, where relationships between predictor variables and dependent variables are determined and weighted.

### Data Stores

In some embodiments, the platforms, systems, media, and methods disclosed herein include one or more data stores. Data stores include repositories for persistently storing and managing collections of data. Types of data stores repositories include, for example, databases and simpler store types, or use of the same. Simpler store types include files, emails, and so forth. In some embodiments, a database is a series of bytes that is managed by a database management system (DBMS). In various embodiments, suitable databases include, by way of non-limiting examples, relational databases, non-relational databases, object-oriented databases, object databases, entity-relationship model databases, associative databases, and extensible markup language (XML) databases. Further non-limiting examples include structured query language (SQL), PostgreSQL, MySQL, Oracle, DB2, and Sybase. In some embodiments, a database is cloud computing based.

### Standalone Application

In some embodiments, a computer program includes a standalone application, which is a program that is run as an independent computer process, not an add-on to an existing process, (e.g., not a plug-in). Standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications.

### Software Modules

In some embodiments, the systems and methods disclosed herein include software, server, or database modules. Software modules are created using machines, software, and languages. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

Furthermore, the modules, processes systems, and sections may be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various Figures of and for embodiments above may be distributed across multiple computers or systems or may be co-located in a single processor or system. Example structural embodiment alternatives suitable for implementing the modules, sections, systems, means, or processes described herein are provided below.

The modules, processors, or systems described above may be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

The following are enumerated examples of methods, devices, and non-transitory computer-readable media of the present application.

Example 1. A method for providing classification parameters executed by an electronic processing device, the method comprising: receiving a test set comprising unlabeled data to classify; pooling the test set and a training set into a concatenated dataset comprising a plurality of parameters, wherein the training set comprises labeled data; normalizing the concatenated dataset; non-linearly reducing a dimensionality of the normalized concatenated dataset to a reduced dimension space; computing classification parameters by classifying the unlabeled data from the reduced dimension space using the labeled data from the reduced dimension space; and providing the classification parameters for further processing.

Example 2. The method of example 1, wherein the concatenated dataset is normalized by applying a z-score method.

Example 3. The method of examples 1 or 2, wherein the normalized concatenated dataset provides spatial location consistency between the labeled data and the unlabeled data in a same reduced dimension space.

Example 4. The method of example 3, wherein the unlabeled data is classified using a K-nearest neighbors (k-NN) classifier.

Example 5. The method of any of examples 1-4, wherein the classification parameters comprise a particle class, a confidence score, or coordinates in the reduced dimension space.

Example 6. The method of any of examples 1-5, further comprising: determining a plurality of image parameters by processing the test set through an image processing model; and extracting singlets by applying image feature gates to the plurality of image parameters.

Example 7. The method of example 6, wherein the image processing model includes a classifier model selected by a user.

Example 8. The method of examples 6 or 7, wherein the plurality of image parameters includes flow parameters or fluorescence parameters.

Example 9. The method of any of examples 6-8, wherein the plurality of image parameters includes cell size, a number of particles, or pixel intensity-based parameters.

Example 10. The method of any of examples 1-9, further comprising: generating the training set by: generating a two-dimensional (2D) map by applying a dimensionality reduction technique to a normalized data set comprising flow parameters, image parameters, or flow parameters and image parameters; and generating a clustering map comprising a plurality of clusters by applying a clustering algorithm to the 2D map, wherein the labeled data comprises the plurality of clusters.

Example 11. The method of example 10, wherein each of the plurality of clusters corresponds to a class determined according to user input.

Example 12. The method of examples 10 or 11, wherein the dimensionality reduction technique comprises a nonlinear dimensionality reduction technique or a linear dimensionality reduction technique.

Example 13. The method of example 12, wherein the linear dimensionality reduction technique comprises random projection and Principal Component Analysis (PCA).

Example 14. The method of example 12, wherein the nonlinear dimensionality reduction technique comprises kernel principal component analysis (KernelPCA), Isometric Mapping (Isomap) embedding, Uniform Manifold Approximation and Projection (UMAP), or t-distributed Stochastic Neighbor Embedding (t-SNE).

Example 15. The method of any of examples 10-14, wherein the normalized concatenated dataset is reduced to the reduced dimension space using the dimensionality reduction technique.

Example 16. The method of any of examples 10-14, wherein the normalized concatenated dataset is reduced to the reduced dimension space using a different dimensionality reduction technique than the dimensionality reduction technique applied to the normalized data set.

Example 17. The method of any of examples 10-16, wherein the clustering algorithm comprises an agglomerative clustering algorithm, a k-means clustering algorithm, a spectral clustering algorithm, a mean-shift clustering algorithm, or a Density-Based Spatial Clustering of Applications with Noise (DBSCAN) clustering algorithm.

Example 18. The method of any of examples 10-17, wherein the training set is generated from a stained cells experiment acquired by a flow cytometer.

Example 19. The method of any of claims 1-18, further comprising: generating the training set by gating a plurality of flow parameters into a plurality of gates, wherein each of the plurality of gates comprises a group of images; and wherein the training set comprises the plurality of gates.

Example 20. The method of any of claims 1-18, further comprising: generating the training set by grouping a plurality of images according to a similarity metric respective to a plurality of defined images, wherein each of the defined images is associated with a unique particle class.

Example 21. The method of example 20, wherein the similarity metric is expressed in percentage.

Example 22. The method of example 21, wherein the percentage is thresholded to associate the plurality of images above a predetermined threshold with the unique particle class.

Example 23. The method of example 20, wherein the similarity metric is based on a Euclidean distance in image parameter space.

Example 24. The method of example 23, wherein the Euclidean distance in the image parameter space is defined according to:

$$d ( \vec{p} , \vec{q} ) = \sqrt{{\sum }_{i = 1}^{N} {( {p}_{i} - {q}_{i} )}^{2}}$$

where \vec{p},\vec{q}: are two points in a normalized image parameter space, N is a dimension of the normalized image parameter space.

Example 25. The method of example 24, where each image parameter is weighted according to a feature ranking analysis.

Example 26. The method of example 24, wherein the similarity metric is expressed in percentage according to:

$$s ( \vec{p} , \vec{q} ) = 100 \times ( 1 - \frac{d ( \vec{p} , \vec{q} )}{d ( - \vec{2 σ} , + \vec{2 σ} )} )$$

where s(\vec{p},\vec{q}) is particle similarity (%), σ is a standard deviation, and d(−\vec{2σ}, +\vec{2σ}) is a farthest distance covering a 95% confidence interval (2σ) assuming normally distributed data.

Example 27. The method of example 21, wherein a confidence score of the similarity metric is defined by fitting a Gaussian probability density function to a normalized histogram of the similarity metric.

Example 28. The method of example 21, further comprising calculating a particle similarity confidence score from fitting a Gaussian function [symbol] ₛ to a normalized histogram of particle similarity hₛ with a binning of 1.

Example 29. The method of example 28, wherein the Gaussian function is a probability density function of normal distribution defined as:

$${𝒩}_{s} = A \frac{1}{ρ \sqrt{2 π}} {e}^{- \frac{{( s - μ )}^{2}}{2 {ρ}^{2}}}$$

where s: particle similarity; A: area under curve parameter; μ: mean parameter; and ρ: standard deviation parameter.

Example 30. The method of example 29, wherein the particle similarity confidence score K is defined by a coefficient of determination defined as:

$$κ = 100 \times ( 1 - \frac{RSS}{TSS} )$$

where RSS: residual sum of squares, RSS=Σₛ₌₀¹⁰⁰(hₛ− [symbol] ₛ)²; and TSS: total sum of squares, TSS=Σₛ₌₀¹⁰⁰(hₛ−h̅)² with

$$\overline{h} = \frac{1}{101} {\sum }_{s = 0}^{100} {h}_{s} .$$

Example 31. The method of example 21, further comprising calculating a confidence score per image parameter from a normalized histogram of each image parameter.

Example 32. The method of example 31, further comprising calculating a global confidence score as an average of confidence scores per image parameter.

Example 33. The method of any of examples 1-32, wherein the test set and the training set each comprise flow cytometry data.

Example 34. The method of any of examples 1-33, wherein the further processing includes population statistics analysis of classified particles.

Example 35. The method of any of examples 1-34, wherein the concatenated dataset is normalized by applying a z-score method applied to the plurality of parameters.

Example 36. The method of any of examples 1-35, wherein the further processing includes determining a plurality of population statistics.

Example 37. The method of example 36, wherein the plurality of population statistics includes a percentage of live, apoptotic, and dead cells.

Example 38. The method of example 36, wherein the plurality of population statistics includes a percentage of different degree of cell response to a given therapy or a panel of therapies.

Example 39. A particle classification system, comprising: an electronic processing device configured to: receive, from an imaging flow cytometer instrument, a test set comprising unlabeled data to classify; pool the test set and a training set into a concatenated dataset comprising a plurality of parameters, wherein the training set comprises labeled data; normalize the concatenated dataset by bringing a variance to one for each of the plurality of parameters; non-linearly reduce a dimensionality of the normalized concatenated dataset to a reduced dimension space; compute classification parameters by classifying the unlabeled data from the reduced dimension space using the labeled data from the reduced dimension space; and provide the classification parameters for further processing.

Example 40. The particle classification system of example 39, wherein the electronic processing device is further configured to: determine a plurality of image parameters by processing the test set through an image processing model; and extract singlets by applying image feature gates to the plurality of image parameters.

Example 41. The particle classification system of examples 39 or 40, wherein the electronic processing device is further configured to generate the training set by: generating a two-dimensional (2D) map by applying a dimensionality reduction technique to a normalized data set comprising flow parameters, or image parameters, or flow and image parameters; and generating a clustering map comprising a plurality of clusters by applying a clustering algorithm to the 2D map, wherein the labeled data comprises the plurality of clusters.

Example 42. The particle classification system of any of examples 39-41, wherein the electronic processing device is further configured to generate the training set by: generating the training set by gating a plurality of flow parameters into a plurality of gates, wherein each of the plurality of gates comprises a group of images; and wherein the training set comprises the plurality of gates.

Example 43. The particle classification system of any of examples 39-42, wherein the electronic processing device is further configured to generate the training set by: generating the training set by grouping a plurality of images according to a similarity metric respective to a plurality of defined images, wherein each of the defined images is associated with a unique particle class.

Example 44. A system to analyze cells, the system comprising: a flow cytometer; and a particle classification system as recited in any of examples 39-43.

Example 45. A method for computing classification parameters executed by an electronic processing device, the method comprising: receiving a test set comprising unlabeled data to classify; non-linearly reducing, to a reduced dimension space, a dimensionality of a normalized concatenated dataset comprising the test set and a training set comprising labeled data; and computing classification parameters by classifying the unlabeled data from the reduced dimension space using the labeled data from the reduced dimension space.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

As described above in the detailed description, reference is made to the accompanying drawings that form a part hereof wherein like numerals designate like parts throughout, and in which is shown, by way of illustration, implementations that may be practiced. It is to be understood that other implementations may be utilized, and structured or logical changes may be made, without departing from the scope of the present disclosure. Therefore, the detailed description as described above is not to be taken in a limiting sense.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future (e.g., any elements developed that perform the same function, regardless of structure).

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Various operations may be described as multiple discrete actions or operations in turn, in a manner that is most helpful in understanding the subject matter disclosed herein. However, the order of description should be construed as to imply that these operations are necessarily order dependent. In particular, these operations may not be performed in the order of presentation. Operations described may be performed in a different order from the described implementation. Various additional operations may be performed, and/or described operations may be omitted in additional implementations.

What is claimed is:

1. A method for providing classification parameters executed by an electronic processing device, the method comprising:
receiving a test set comprising unlabeled data to classify;
pooling the test set and a training set into a concatenated dataset comprising a plurality of parameters, wherein the training set comprises labeled data;
normalizing the concatenated dataset;
non-linearly reducing a dimensionality of the normalized concatenated dataset to a reduced dimension space;
computing classification parameters by classifying the unlabeled data from the reduced dimension space using the labeled data from the reduced dimension space; and
providing the classification parameters for further processing.

2. The method of claim 1, wherein the concatenated dataset is normalized by applying a z-score method.

3. The method of claim 1, wherein the normalized concatenated dataset provides spatial location consistency between the labeled data and the unlabeled data in a same reduced dimension space.

4. The method of claim 3, wherein the unlabeled data is classified using a K-nearest neighbors (k-NN) classifier.

5. The method of claim 1, wherein the classification parameters comprise a particle class, a confidence score, or coordinates in the reduced dimension space.

6. The method of claim 1, further comprising:
determining a plurality of image parameters by processing the test set through an image processing model; and
extracting singlets by applying image feature gates to the plurality of image parameters.

7. The method of claim 6, wherein the image processing model includes a classifier model selected by a user.

8. The method of claim 6, wherein the plurality of image parameters includes flow parameters or fluorescence parameters.

9. The method of claim 6, wherein the plurality of image parameters includes cell size, a number of particles, or pixel intensity-based parameters.

10. The method of claim 1, further comprising:
generating the training set by:
generating a two-dimensional (2D) map by applying a dimensionality reduction technique to a normalized data set comprising flow parameters, image parameters, or flow parameters and image parameters; and
generating a clustering map comprising a plurality of clusters by applying a clustering algorithm to the 2D map,
wherein the labeled data comprises the plurality of clusters.

11. The method of claim 10, wherein each of the plurality of clusters corresponds to a class determined according to user input.

12. The method of claim 10, wherein the dimensionality reduction technique comprises a nonlinear dimensionality reduction technique or a linear dimensionality reduction technique.

13. The method of claim 12, wherein the linear dimensionality reduction technique comprises random projection and Principal Component Analysis (PCA).

14. The method of claim 12, wherein the nonlinear dimensionality reduction technique comprises kernel principal component analysis (KernelPCA), Isometric Mapping (Isomap) embedding, Uniform Manifold Approximation and Projection (UMAP), or t-distributed Stochastic Neighbor Embedding (t-SNE).

15. The method of claim 10, wherein the normalized concatenated dataset is reduced to the reduced dimension space using the dimensionality reduction technique or a different dimensionality reduction technique than the dimensionality reduction technique applied to the normalized data set.

16. The method of claim 10, wherein the clustering algorithm comprises an agglomerative clustering algorithm, a k-means clustering algorithm, a spectral clustering algorithm, a mean-shift clustering algorithm, or a Density-Based Spatial Clustering of Applications with Noise (DBSCAN) clustering algorithm.

17. The method of claim 1, further comprising:
generating the training set by gating a plurality of flow parameters into a plurality of gates, wherein each of the plurality of gates comprises a group of images; and wherein the training set comprises the plurality of gates.

18. The method of claim 1, further comprising:
generating the training set by grouping a plurality of images according to a similarity metric respective to a plurality of defined images, wherein each of the defined images is associated with a unique particle class, wherein the similarity metric is expressed in percentage based on a Euclidean distance in image parameter space.

19. A particle classification system, comprising:
an electronic processing device configured to:
receive, from an imaging flow cytometer instrument, a test set comprising unlabeled data to classify;
pool the test set and a training set into a concatenated dataset comprising a plurality of parameters, wherein the training set comprises labeled data;
normalize the concatenated dataset by bringing a variance to one for each of the plurality of parameters;
non-linearly reduce a dimensionality of the normalized concatenated dataset to a reduced dimension space;
compute classification parameters by classifying the unlabeled data from the reduced dimension space using the labeled data from the reduced dimension space; and
provide the classification parameters for further processing.

20. A method for computing classification parameters executed by an electronic processing device, the method comprising:
receiving a test set comprising unlabeled data to classify;
non-linearly reducing, to a reduced dimension space, a dimensionality of a normalized concatenated dataset comprising the test set and a training set comprising labeled data; and
computing classification parameters by classifying the unlabeled data from the reduced dimension space using the labeled data from the reduced dimension space.
